(19) United States
(12) Patent Application Publication
(10) Pub. No.: US 2015/0310863 A1
(43) Pub. Date: Oct. 29, 2015

(54) METHOD AND APPARATUS FOR SPEAKER DIARIZATION

(71) Applicant: NUANCE COMMUNICATIONS, INC., Burlington, MA (US)

(72) Inventors: Bei Di Chen, Brossard (CA); Lin Wang, LaSalle (CA)

(73) Assignee: NUANCE COMMUNICATIONS, INC., Burlington, MA (US)

(21) Appl. No.: 14/260,310

(22) Filed: Apr. 24, 2014

(51) Int. Cl. G10L 15/26

(52) U.S. Cl. CPC G10L 15/26

(57) ABSTRACT

A method and apparatus records at a first mobile device, separately, each of an upstream component and a downstream component of a speech data associated with users of the first mobile device and a second mobile device in a full-duplex communication system. Speech endpointing is performing on each recorded component to delimit speech chunks in each component using timing information common to both components. The speech chunks are converted to text chunks using at least one automatic speech recognition process and the text chunks are displayed, based on the timing information, in chronological order on a graphical user interface of the first mobile device as diarized text.

### FIELD OF THE INVENTION

The present invention is related generally to the field of automatic speech recognition and more particularly to speech to text diarization of recorded conversation.

### BACKGROUND OF THE INVENTION

Automatic speech recognition (ASR) systems convert spoken words to text. ASR is a powerful tool for users to provide input to and interface with a computer. Among its many uses, ASR can be used to ‘speech-enable’ applications that use text as input. Output text from an ASR system can be used as input to a wide variety of systems and processes to implement varying tasks including, for example, controlling a device such as a mobile phone, to responding to spoken user queries, to speech transcription with the sole purpose of memorializing spoken words in text format.

Speaker diarization is the process of segmenting a multi-speaker audio stream into speaker homogenous segments and clustering segments according to speaker identity to represent a dialog in text format. Speaker segmentation is a computationally expensive process of identifying change points in an audio input where the speaker changes. Segment clustering is the process of clustering segments according to speakers' identities. Speaker segmentation algorithms and segment clustering algorithms process the acoustic feature vectors of the frames of input audio data.

Speaker diarization is useful as an easy reference to a past multi-party conversation without a need to listen to an audio recording of a conversation in its entirety. Known speaker segmentation and clustering methods for speaker diarization are computationally expensive.

What is needed is a simplified solution for speaker diarization of a multi-party conversation that produces a diarized text output presented to a user in a useful and intuitive interface.

### SUMMARY OF THE INVENTION

Embodiments of the invention provide a method and system for speaker diarization that records, separately, each of an upstream component and a downstream component of a conversation between users of mobile devices in a full-duplex communication system. Speech endpointing is performed on each recorded component to delimit speech chunks in each component using timing information common to both components. The speech chunks are converted to text chunks using at least one automatic speech recognition process. Based on the timing information, the text chunks are displayed in chronological order on a graphical user interface of at least one the mobile devices.

In one embodiment, the chronologically ordered text chunks are displayed vertically, having text chunks with earlier timing information displayed above text chunks having later timing information.

In another embodiment, the vertically displayed text chunks associated with the upstream component are horizontally offset from displayed text chunks associated with the downstream component.

### BRIEF DESCRIPTION OF THE DRAWINGS

FIG. 1 is a block diagram of an exemplary operating environment for the invention;

FIG. 2 is a block diagram of a system and method for speaker diarization according to an embodiment of the invention; and

FIG. 3 is an illustration of a user interface according to an embodiment of the invention.

### DETAILED DESCRIPTION OF THE PREFERRED EMBODIMENTS

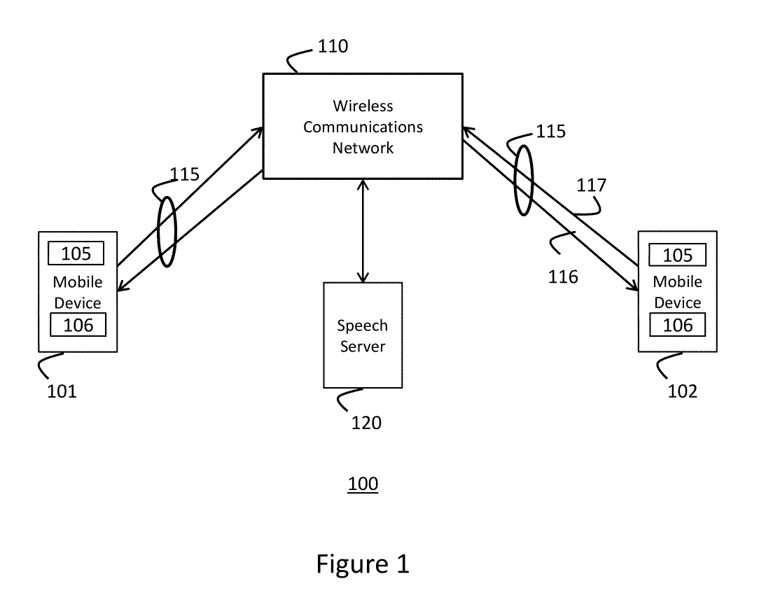

FIG. 1 is a functional block diagram of a mobile communications network 100 to illustrate an operating environment of the present invention. Mobile devices 101-102 are shown as being in wireless or radiated communication with wireless communication network 110. Mobile devices can be wireless phones, including smart phones, personal digital assistants, and tablet computers, and any other mobile devices operable to perform full duplex communication. In one embodiment, a speech server 120 is communicatively coupled to wireless communication network 110. Wireless communications network 110 may be a full-duplex packet-based or circuit switched network, as are known in the art.

Speech server 120 is communicatively coupled to wireless network 110 and is operable to convert speech in an audio signal to text, known in the art as speech-to-text (STT) functionality. Alternatively, in another embodiment of the invention, each mobile device 101-102 includes an STT component 105 operable to convert speech in an audio signal to text at the mobile device. A wireless mobile device according to the invention also includes a speech endpointer 106.

In one exemplary embodiment, when engaging in a communications sessions, e.g., a conversation over a telephone call, each mobile device participating in the call sends and receives speech data over an associated communications channel, e.g. voice channel 115. Each voice channel 115 includes an upstream component 116 associated with a mobile device, the upstream component received by the mobile device, and a downstream component 117 associated with the mobile device, the downstream component sent from the mobile device. According to the preceding description, it is understood that when mobile devices 101 and 102 are engaged in a communications session, the upstream component 117 associated with mobile device 101 is the downstream component 117 associated with mobile device 102.

It will be appreciated that communications network 110, mobile devices 101-102, and speech server 120 can each be implemented with one or more specialized or general-purpose computer systems. Such systems commonly include a high speed processing unit (CPU) in conjunction with a memory system (with volatile and/or non-volatile memory), an input device, and an output device, as is known in the art.

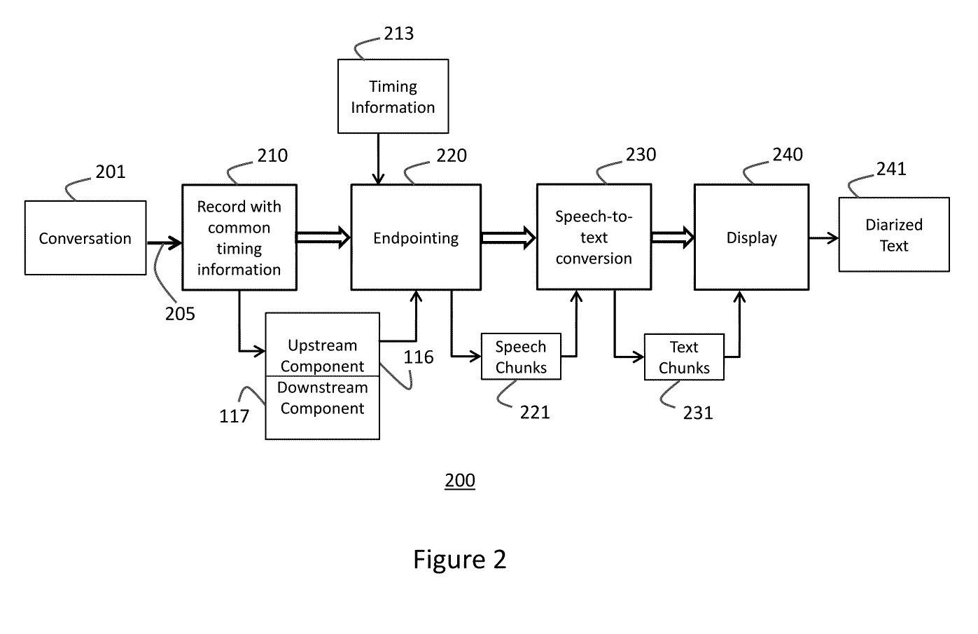

FIG. 2 is a block diagram of system and method for speaker diarization 200 according to an embodiment of the invention. At least one mobile device records 210, each of the upstream component 116 and the downstream component 117 of speech data 205 from a conversation 201 between users of mobile devices in a full-duplex wireless communication system. At the at least one mobile device, endpointer 106 performs speech endpointing 220 on each recorded component 116 and 117 to delimit speech chunks 221 in each component using timing information 213 common to both components. The timing information 213 associated with each speech chunk delimits a start time and end time of the speech chunk. In a preferred embodiment, the timing information is provided by an internal clock of the mobile device. The speech chunks 221 are converted 230 to text chunks 231 using at least one automatic speech recognition process.

In a preferred embodiment, the at least one mobile device transmits speech chunks 221 to speech server 120 via the communications network 110. Speech server 120 receives speech chunks 221 and performs automatic speech recognition on the speech chunks to convert 230 the speech chunks to text chunks 231. Speech server 120 then transmits text chunks 231 to the mobile device via the communications network 110. In another embodiment, one or more of the mobile devices may have automatic speech recognition functionality resident on the device.

In a preferred embodiment, based on the timing information 213, the text chunks 231 are displayed 240 in chronological order as diarized text 241 on a graphical user interface of the mobile device.

The recording 210 is performed separately for each of the upstream component 116 and the downstream component 117 of the conversation 201. In full duplex communications systems, such as a cellular network, communication in both directions happens simultaneously due to the use of separate communications channels for each of the upstream and downstream components of the voice channel 115. The invention obviates the need for known speaker segmentation methods because each user's speech is on a component of the voice channel 115 distinct from the component associated with the other user's speech.

The endpointing 220, which detects a spoken word or words between periods of silence, including ambient background noise, is performed on each recorded component 116 and 117 to delimit the speech chunks 221 in each recorded component. Many end-point detection algorithms are known in the art. Optimally, the goal of the endpointing according to the invention is to identify individual words or groupings of words, i.e. the speech chunks 221, that make up each user's contributions to the conversation as the users alternate speaking to each other. In one embodiment, timing begins at the start of recording the speech data. The timing information associated with each speech chunk can be two timestamps, one inserted by the endpointer at the beginning and one inserted at the end of each spoken word or words occurring between periods of silence in a recorded component of the speech data 205.

The speech chunks 221 are converted to text chunks 231 using at least one automatic speech recognition process. It should be understood that speech server 110 performs endpointing of individual words in speech in order to perform speech to text conversion as is known in conventional automatic speech recognition (ASR) systems and methods.

Using the timing information 213 common to both components 116 and 117, the text chunks 231 are displayed 241 as diarized text 241 on a graphical user interface of the associated mobile device.

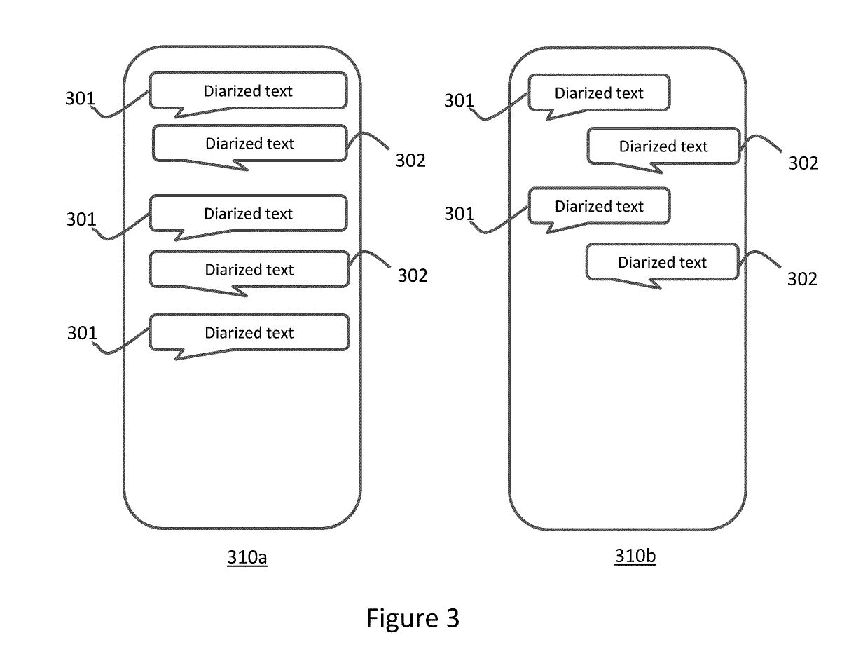

FIG. 3 shows embodiments of graphical user interface 310a and 310b displaying diarized text 301-302 on a mobile device according to the invention. Graphical user interface 310a shows diarized text 301 associated with the upstream component 116 displayed vertically with diarized text 302 associated with the downstream component 117 in chronological order according to the timing information associated with the text chunks. The vertical order may include text chunks associated with earlier timing information situated at either the top or the bottom of the graphical user interface, with text chunks having later associated timing information displayed below or above, respectively.

Further, as shown on graphical user interface 310b, the chronologically ordered text chunks are displayed vertically and text chunks associated with each of the upstream and downstream components are offset horizontally.

The diarized text may be stored locally on the mobile device or remotely. Diarized text may be associated with a user and labelled accordingly on the graphical user interface using contact information relevant to the users participating in the conversation that is stored in a contact list or call logging application.

It will be understood, and is appreciated by persons skilled in the art, that one or more methods or method steps described in connection with FIGS. 1-3 may be performed by hardware and/or software. If the process is performed by software, the software may reside in software memory (not shown) in a suitable electronic processing component or system. The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable (or signal-bearing) medium for use by or in connection with an instruction execution system, apparatus, or device, such as a computer-based system, processor-containing system, or other system that may selectively fetch the instructions from the instruction execution system, apparatus, or device and execute the instructions.

In the context of this disclosure, a “computer-readable medium” and/or “signal-bearing medium” is any means that may contain, store, communicate, propagate, or transport the program for use by or in connection with the instruction execution system, apparatus, or device. The computer readable medium may selectively be, for example, but is not limited to, an electronic, magnetic, optical, electromagnetic, infrared, or semiconductor system, apparatus, device, or propagation medium. More specific examples, but nonetheless a non-exhaustive list, of computer-readable media would include the following: an electrical connection (electronic) having one or more wires, a portable computer diskette (magnetic), a RAM (electronic), a read-only memory “ROM” (electronic), an erasable programmable read-only memory (EPROM or Flash memory) (electronic), an optical fiber (optical), and a portable compact disc read-only memory “CDROM” (optical).

Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

We claim:

1. A method for speaker diarization, comprising:
recording at a first mobile device, separately, each of an upstream component and a downstream component of a speech data associated with users of the first mobile device and a second mobile device in a full-duplex communication system;
performing speech endpointing on each recorded component to delimit speech chunks in each component using timing information common to both components;
converting the speech chunks to text chunks using at least one automatic speech recognition process;
displaying, based on the timing information, the text chunks in chronological order on a graphical user interface of the first mobile device as diarized text.

2. The method of claim 1, wherein the chronologically ordered text chunks are displayed vertically, having text chunks with earlier timing information displayed above text chunks having later timing information.

3. The method of claim 1, further comprising;
offsetting, horizontally, the vertically displayed text chunks associated with the upstream component from displayed text chunks associated with the downstream component.

4. The method of claim 1, wherein the first mobile device associated with a first user.

5. The method of claim 4, wherein the upstream component includes speech data associated with a second user of a second mobile device.

6. The method of claim 4, wherein the downstream component includes speech data associated with the first user.

7. The method of claim 1 wherein the timing information is provided by an internal clock of the mobile device.

8. The method of claim 1, wherein the converting further comprises:
transmitting the speech chunks to a speech server via the communications network.

9. The method of claim 8, wherein the converting further comprises:
receiving text chunks associated with the speech chunks from the speech server via the communications network.

10. The method of claim 1, wherein the converting is performed on the mobile device.

11. The method of claim 1, wherein the endpointing detects a set of spoken words between periods of silence, wherein the set includes at least one word.

12. The method of claim 11, further comprising;
inserting a first time stamp at the beginning of each set of spoken words occurring between periods of silence in a recorded component of the speech data; and
inserting a second time stamp at the end of each set of spoken words occurring between periods of silence in the recorded component of the speech.

13. The method of claim 1, further comprising:
storing the diarized text on the mobile device.

14. The method of claim 5, further comprising:
labelling the diarized text according to the associated user.

15. A mobile device, comprising:
memory operable to record, separately, each of an upstream component and a downstream component of a conversation between users of devices in a full-duplex communication system;
a speech endpointer configured to delimit speech chunks in each component using timing information common to both components;
an automatic speech recognizer operable to convert the speech chunks to text chunks using at least one automatic speech recognition process; and
a graphical user interface configured to display, based on the timing information, the text chunks in chronological order a diarized text.

16. The mobile device of claim 15, wherein graphical user interface is further configured to display the text chunks vertically, whereby text chunks with earlier timing information are displayed above text chunks having later timing information.

17. The method of claim 16, wherein graphical user interface is further configured to offsett, horizontally, the vertically displayed text chunks associated with the upstream component from displayed text chunks associated with the downstream component.

18. The mobile device of claim 1 further comprising am internal clock to provide the timing information.

19. The method of claim 15, wherein the endpointer is further configured to detect a set of spoken words between periods of silence, wherein the set includes at least one word.

20. The mobile device of claim 19, wherein the endpointer is further configured to insert a first time stamp at the beginning of each set of spoken words occurring between periods of silence in a recorded component of the speech data and to insert a second time stamp at the end of each set of spoken words occurring between periods of silence in the recorded component of the speech.
